(19) United States
(12) Patent Application Publication
(10) Pub. No.: US 2007/0115243 A1
(43) Pub. Date: May 24, 2007

(54) Precharging circuits for a signal line of an Liquid Crystal Display (LCD) in which the precharge voltage is based on the magnitude of a gray-scale voltage corresponding to image data and related LCD systems, drivers, and methods

(75) Inventors: Hyung-Tae Kim, Gyeonggi-do (KR); Woo-Nyoung Lee, Gyeonggi-do (KR)

Correspondence Address: MYERS BIGEL SIBLEY & SAJOVEC, PO BOX 37428, RALEIGH, NC, 27627, US

(73) Assignee: SAMSUNG ELECTRONICS CO., LTD.

(21) Appl. No.: 11/540,241

(22) Filed: Sep. 29, 2006

(30) Foreign Application Priority Data
Nov. 21, 2005 (KR) 10-2005-0111283

(51) Int. Cl. G09G 3/36

(52) U.S. Cl. 345/100

(57) ABSTRACT

An LCD system includes a TFT-LCD panel and at least one driving device for driving the TFT-LCD panel. The LCD driver includes a decoder, an output buffer and a precharging circuit. The precharging circuit receives a gray-scale voltage corresponding to source data in response to a first precharge control signal and outputs a precharge voltage to the signal line that is based on a magnitude of the gray-scale voltage.

### RELATED APPLICATION

This application claims the benefit of and priority to Korean Patent Application No. 10-2005-0111283, filed Nov. 21, 2005, in the Korean Intellectual Property Office, the disclosure of which is hereby incorporated herein by reference as if set forth in its entirety.

### BACKGROUND OF THE INVENTION

1. Field of the Invention

The present invention relates to TFT (Thin Film Transistor) LCDs (Liquid Crystal Devices) and, more particularly, to signal line precharging circuits for a TFT-LCD and a TFT-LCD driver comprising the same.

2. Description of Related Art

FIG. 1 is a block diagram schematically showing a conventional TFT-LCD. Referring to FIG. 1, the TFT-LCD 100 comprises a source driver 200, a gate driver 300, and a TFT-LCD panel 400.

The TFT-LCD panel 400 comprises a plurality of pixels connected between a plurality of signal lines 50_1 to 50_N and a plurality of gate lines. Each pixel may be modeled as a capacitor 411. The gate driver 300 sequentially drives the gate line connected to a gate electrode of a TFT 412. That is, the gate driver 300 applies a predetermined voltage to the gate electrode of the TFT 412 to turn on TFT 412. The source driver 200 applies a source driving voltage for displaying an image signal to respective signal lines 50_1, 50_2, . . . and 50_N, whereby an image is displayed on the TFT-LCD panel 400.

The output circuit of the source driver 200 increases a driving capability of an input voltage when it is output to the signal line. Meanwhile, high resolution or large size TFT-LCD panels may benefit from a high driving capability due to a low slew rate and a high load. Also, large TFT-LCD panels may use a plurality of source driver chips.

Increase of the current driving capability leads peak current to instantaneously increase, which may cause EMI (electro magnetic interference) problems and heat generation. To address the problems of EMI and heat generation, the peak current may be reduced by precharging the signal lines to predetermined voltage levels prior to applying the output voltage to the signal-lines.

Korean Publication Patent No. 10-2003-0069652 discloses a conventional technique for precharging the signal lines. FIG. 6 is a schematic view of the LCD disclosed in Korean Publication Patent No. 10-2003-0069652. Referring to FIG. 6, the LCD 280 comprises a precharge timing control circuit 281, a mode selection circuit 282, a precharge voltage selection circuit 283, and an output circuit 284.

The precharge timing control circuit 281 outputs a precharge timing control signal PRECNT to the output circuit 284 in response to the combination of a clock signal CLK1 and a predetermined input signal CNT1. The mode selection circuit 282 outputs a mode selection signal MOD by combining the most significant bits of a polar control signal POL and data DATA. The mode selection signal MOD determines whether the signal line 50_1, . . . and 50_N is precharged or not. The precharge voltage selection circuit 283 outputs one voltage VSEL selected from two precharge voltages VHC and VLC having different voltage levels to the output circuit 284 in response to the combination of the most significant bits of the polar control signal POL and the data DATA. The output circuit 284 outputs the selected precharge voltage VSEL to the signal line 50_1, 50_2, . . . and 50_N in response to the precharge timing control signal PRECNT in the precharge mode.

The conventional signal line precharging method as described above uses circuits for generating a plurality of precharge voltages VHC and VLC. That is, separate external or internal voltage generators are used. Also, every channel (signal line) uses logic to check the polarity of the most significant bit MSB of data DATA to select any one precharge voltage among the plurality of precharge voltage VHC and VLC. Therefore, the conventional circuit for precharging the signal lines is relatively complicated and may require a large amount of chip area. Further, because the precharge voltage level is selected from a plurality of voltage levels, the precharge voltage level can not be variably changed.

### SUMMARY

In some embodiments of the present invention, a circuit for precharging signal lines of an LCD includes a precharge voltage generating circuit that is configured to generate a precharge voltage on a signal line responsive to a precharge control signal and a gray-scale voltage, the precharge voltage having a magnitude that is based on a magnitude of the gray-scale voltage.

In other embodiments, the precharge voltage generating circuit is a first precharge voltage generating circuit, the precharge control signal is a first precharge control signal, and the precharge voltage is a first precharge voltage. The circuit further comprises a second precharge voltage generating circuit that is configured to generate a second precharge voltage on the signal line responsive to a second precharge control signal and the gray-scale voltage, the second precharge voltage having a magnitude that is based on the magnitude of the gray-scale voltage.

In still other embodiments, the first precharge voltage generating circuit comprises a first switch that is operable responsive to the first precharge control signal and a first transistor that comprises a first terminal that is connected to a first supply voltage, a second terminal that is connected to a terminal of the first switch and a third terminal that is connected to the signal line. The first precharge control signal is activated responsive to a clock signal and a polarity control signal.

In still other embodiments, the second precharge voltage generating circuit comprises a second switch that is operable responsive to the second precharge control signal and a second transistor that comprises a first terminal that is connected to a second supply voltage, a second terminal that is connected to a terminal of the second switch and a third terminal that is connected to the signal line. The second precharge control signal is activated responsive to the clock signal and the polarity control signal.

In still other embodiments, the first transistor is an NMOS transistor and the second transistor is PMOS transistor.

In further embodiments of the present invention, an LCD driver comprises a decoder that is configured to generate a gray-scale voltage responsive to source data, an output buffer that is configured to drive a signal line of the LCD to an operating voltage responsive to the gray scale voltage, and a precharge voltage generating circuit that is configured to generate a precharge voltage on the signal line responsive to a precharge control signal and the gray-scale voltage, the precharge voltage having a magnitude that is based on a magnitude of the gray-scale voltage.

In still further embodiments, the precharge voltage generating circuit is a first precharge voltage generating circuit, the precharge control signal is a first precharge control signal, and the precharge voltage is a first precharge voltage. The LCD driver further comprises a second precharge voltage generating circuit that is configured to generate a second precharge voltage on the signal line responsive to a second precharge control signal and the gray-scale voltage, the second precharge voltage having a magnitude that is based on the magnitude of the gray-scale voltage.

In still further embodiments, the first precharge voltage generating circuit comprises a first switch that is operable responsive to the first precharge control signal and a first transistor that comprises a first terminal that is connected to a first supply voltage, a second terminal that is connected to a terminal of the first switch and a third terminal that is connected to the signal line. The first precharge control signal is activated responsive to a clock signal and a polarity control signal.

In still further embodiments, the second precharge voltage generating circuit comprises a second switch that is operable responsive to the second precharge control signal and a second transistor that comprises a first terminal that is connected to a second supply voltage, a second terminal that is connected to a terminal of the second switch and a third terminal that is connected to the signal line. The second precharge control signal is activated responsive to the clock signal and the polarity control signal.

In still further embodiments, the first transistor is an NMOS transistor and the second transistor is PMOS transistor.

In still further embodiments, the first precharge voltage is obtained by subtracting a threshold voltage of the first transistor from the gray-scale voltage and the second precharge voltage is a voltage obtained by adding a threshold voltage of the second transistor to the gray-scale voltage.

In still further embodiments, the LCD driver further comprises an output switch that couples the output buffer to the signal line and is operable responsive to an output control signal and a share switch that couples the signal line to another signal line and is operable responsive to a share control signal.

In other embodiments of the present invention, an LCD system comprises a TFT-LCD panel and at least one driving device that is configured to drive the TFT-LCD panel. Each of the at least one driving device comprises a decoder that is configured to generate a gray-scale voltage responsive to source data, an output buffer that is configured to drive a signal line of the LCD to an operating voltage responsive to the gray scale voltage, and a precharge voltage generating circuit that is configured to generate a precharge voltage on the signal line responsive to a precharge control signal and the gray-scale voltage, the precharge voltage having a magnitude that is based on a magnitude of the gray-scale voltage.

In still other embodiments, the precharge voltage generating circuit is a first precharge voltage generating circuit, the precharge control signal is a first precharge control signal, and the precharge voltage is a first precharge voltage. The at least one driving device further comprises a second precharge voltage generating circuit that is configured to generate a second precharge voltage on the signal line responsive to a second precharge control signal and the gray-scale voltage, the second precharge voltage having a magnitude that is based on the magnitude of the gray-scale voltage.

In still other embodiments, the first precharge voltage generating circuit comprises a first switch that is operable responsive to the first precharge control signal and an NMOS transistor that comprises a first terminal that is connected to a first supply voltage, a second terminal that is connected to a terminal of the first switch and a third terminal that is connected to the signal line. The second precharge voltage generating circuit comprises a second switch that is operable responsive to the second precharge control signal and a PMOS transistor that comprises a first terminal that is connected to a second supply voltage, a second terminal that is connected to a terminal of the second switch and a third terminal that is connected to the signal line.

In further embodiments of the present invention, a method of precharging signal lines of an LCD comprises generating a precharge voltage on a signal line responsive to a precharge control signal and a gray-scale voltage, the precharge voltage having a magnitude that is based on a magnitude of the gray-scale voltage.

In still further embodiments, the precharge control signal is a first precharge control signal and the precharge voltage is a first precharge voltage. The method further comprises generating a second precharge voltage on the signal line responsive to a second precharge control signal and the gray-scale voltage, the second precharge voltage having a magnitude that is based on the magnitude of the gray-scale voltage.

In other embodiments of the present invention, a method of operating an LCD system comprises providing a TFT-LCD panel having a plurality of signal lines, generating a gray-scale voltage responsive to source data, driving a respective one of the signal lines of the TFT-LCD panel to an operating voltage responsive to the gray scale voltage, generating a precharge voltage on the signal line responsive to a precharge control signal and the gray-scale voltage, the precharge voltage having a magnitude that is based on a magnitude of the gray-scale voltage.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram schematically showing a conventional TFT-LCD;

FIG. 2 is a block diagram schematically showing a source driver according to some embodiments of the present invention;

FIG. 3 is a circuit diagram of an output circuit according to some embodiments of the present invention;

FIG. 4 is a timing diagram of signals of an output circuit according to some embodiments of the present invention;

FIG. 5 shows change in the threshold voltage according to the voltage difference between the source and the bulk according to some embodiments of the present invention;

FIG. 6 is a schematic view of an LCD disclosed in Korean Publication Patent No. 10-2003-0069652;

FIG. 7 is a graph showing voltage levels of the signal line shown in FIG. 3; and

FIGS. 8A and 8B are graphs of voltage levels of signal lines for a conventional TFT-LCD.

### DETAILED DESCRIPTION OF EMBODIMENTS

While the present invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

It will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements. As used herein, the term “and/or” and “/” includes any and all combinations of one or more of the associated listed items. Like numbers refer to like elements throughout the description.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that although the terms first and second are used herein to describe various components, circuits, regions, layers and/or sections, these components, circuits, regions, layers and/or sections should not be limited by these terms. These terms are only used to distinguish one component, circuit, region, layer or section from another component, circuit, region, layer or section. Thus, a first component, circuit, region, layer or section discussed below could be termed a second component, circuit, region, layer or section, and similarly, a second component, circuit, region, layer or section may be termed a first component, circuit, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

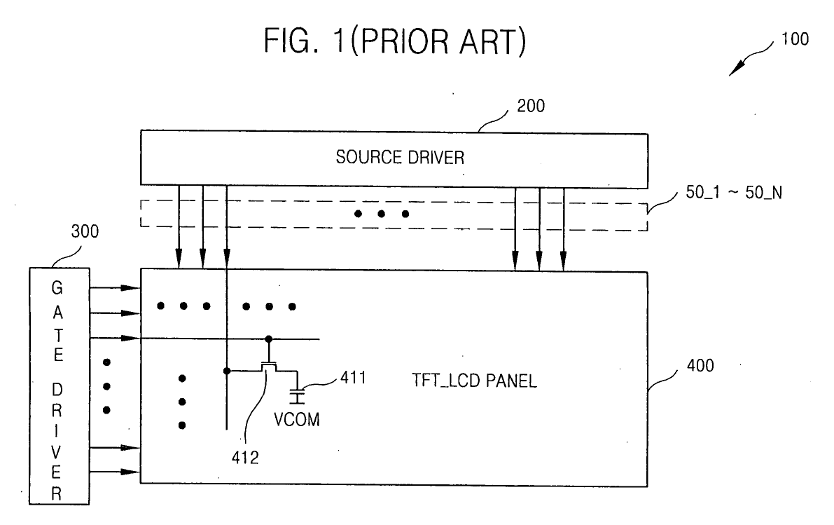

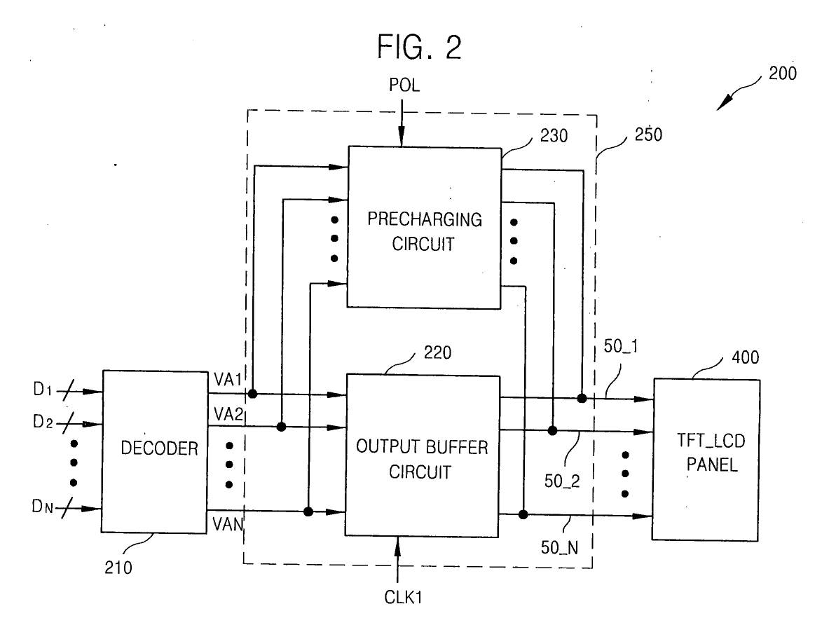

FIG. 2 is a block diagram schematically showing a source driver according to some embodiments of the present invention. The source driver 200 is a device for driving a TFT-LCD panel, such as the TFT-LCD panel 400 as shown in FIG. 1, and may be implemented as a chip separate from a gate driver 300 or a chip integrated with the gate driver 300.

The source driver 200 comprises a decoder 210 and an output circuit 250. The output circuit 250 comprises an output buffer circuit 220 and a precharging circuit 230. The decoder 210 receives a plurality of respective source data D₁, D₂, . . . and D_{N} and outputs gray-scale voltages VA1, VA2, . . . and VAN corresponding to the source data D₁, D₂, . . . and DN. Each of the source data D₁, D₂, . . . and DN comprises a plurality of bits (for example, 8 bits).

The output buffer circuit 220 buffers the gray-scale voltages VA1, VA2, . . . and VAN and outputs them to the corresponding signal line 50_1, 50_2, . . . and 50_N. The precharging circuit 230 generates precharge voltages varying according to the gray-scale voltages VA1, VA2, . . . and VAN and outputs the voltages to the corresponding signal line 50_1, 50_2, . . . and 50_N. Also, the precharging circuit 230 generates different precharge voltages in accordance with the polarity of a polar control signal POL.

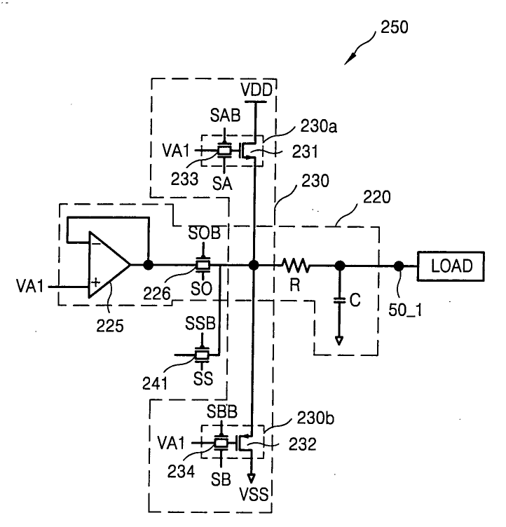

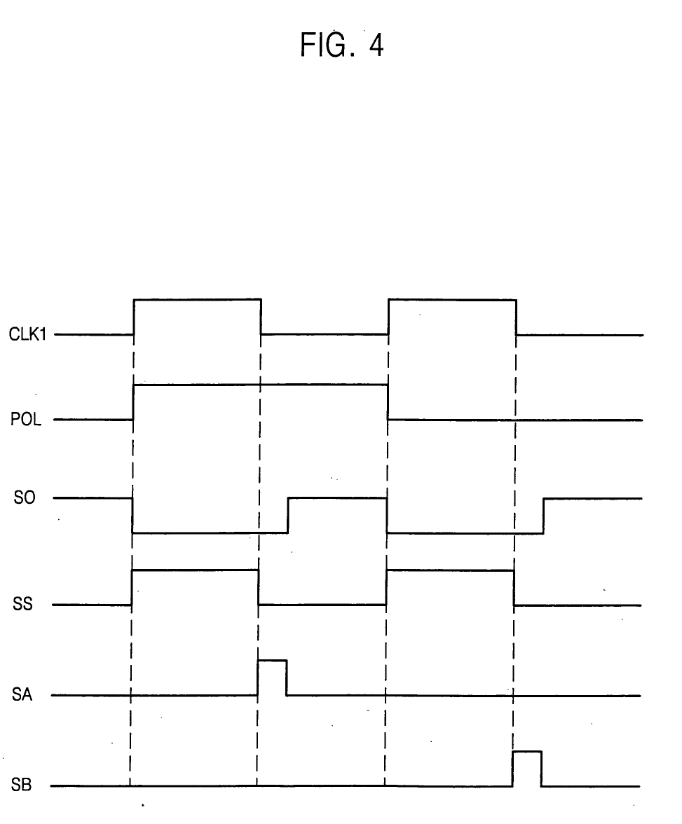

FIG. 3 is a detailed circuit diagram of the output circuit 250 according to some embodiments of the present invention. FIG. 4 is a timing diagram of signals of the output circuit 250. In practice, each of the signal lines 50_1, 50_2, . . . and 50_N is provided with a corresponding output circuit. In FIG. 3, however, only the output circuit 250 corresponding to the first signal line 50_1 is representatively shown because the output circuits to which the respective signal lines 50_1, 50_2, . . . and 50_N correspond are the same.

The output circuit 250 comprises an output buffer circuit 220 and a precharging circuit 230. The output circuit 250 may further comprise a share switch 241. The output buffer circuit 220 comprises a voltage following amplifier 225, an output switch 226, a resistor R, and a capacitor C. The precharging circuit 230 comprises a first precharge voltage generating circuit 230a and a second precharge voltage generating circuit 230b.

The share switch 241 is located between the signal line 50_1 and another adjacent signal line (for example, 50_2). The share switch 241 is opened and closed in response to a share control signal SS and a reverse share control signal SSB so that the signal line 50_1 shares a voltage with another signal line 50_2.

Referring to FIG. 4, a clock signal CLK1 is a signal for line synchronization of an image displayed on the TFT-LCD panel 400. The polar control signal POL is a signal for reversing polarity of the gray-scale voltage VA1 and ensures that a +gray-scale voltage and a −gray-scale voltage, based a common voltage VCOM, are alternately selected. The polar control signal POL has its polarity reversed every cycle of the clock signal CLK1. Therefore, the polar control signal POL has a cycle twice as long as that of the clock signal CLK1. The share control signal SS is a signal that is activated to the high level for a predetermined period of time in response to the clock signal CLK1. In the period where the share control signal SS is activated, the share switch 241 is turned on, whereby the voltage levels of the signal line 50_1 and another signal line 50_2 gradually become equal so that they have the same voltage level.

The first precharge voltage generator circuit 230a includes a first transistor 231 and a first switch 233, which is opened and closed in response to a first precharge control signal SA. The first transistor 231 may be an NMOS transistor (N channel transistor) comprising a drain connected to a first supply voltage VDD, a gate connected to a terminal of the first switch 233, and a source connected to the signal line 50_1.

Because the first switch 233 is opened and closed in response to the first precharge control signal SA, the gray-scale voltage VA1 is selectively output to the gate of the first transistor 231. Thus, when the first switch 233 is closed, the first transistor 231 receives the gray-scale voltage VA1 through the gate. Referring to FIG. 4, the first precharge control signal SA is a signal generated in response to the clock signal CLK1 and the polar control signal POL, and is activated in a predetermined period of time, particularly, when the polar control signal POL has a high level. In more detail, the first precharge control signal SA is activated to the high level in the period when the polar control signal POL has a high level for a predetermined period of time after the share control signal SS is inactivated. In the period of time when the first precharge control signal SA is activated to a high level, the first transistor 231 generates a first precharge voltage that varies according to the gray-scale voltage VA1 and outputs the first pre-charge voltage to the signal line 50_1. Here, the first precharge voltage is a source voltage of the first transistor 231 in which the source voltage has a voltage value obtained by subtracting a threshold voltage Vₜₕ₁ of the first transistor 231 from the gate voltage (gray-scale voltage VA1).

The second precharge voltage generator circuit 230b includes a second transistor 232 and a second switch 234, which is opened and closed in response to a second precharge control signal SB. The second transistor 232 may be a PMOS transistor (P channel transistor) comprising a drain connected to a second supply voltage VSS, a gate connected to a terminal of the second switch 234 and a source connected to the signal line 50_1.

Because the second switch 234 is opened and closed in response to the second precharge control signal SB, the gray-scale voltage VA1 is selectively output to the gate of the second transistor 232. Thus, when the second switch 234 is closed, the second transistor 232 receives the gray-scale voltage VA1 through the gate. Referring to FIG. 4, the second precharge control signal SB is a signal generated in response to the clock signal CLK1 and the polar control signal POL and is activated in a predetermined period of time when the polar control signal POL has a low level. In more detail, the second precharge control signal SB is activated to a high level in the period of time when the polar control signal POL has a low level for a predetermined period of time after the share control signal SS is inactivated. In the period of time when the second precharge control signal SB is activated to a high level, the second transistor 232 generates a second precharge voltage that varies according to the gray-scale voltage VA1 and outputs the second precharge voltage to the signal line 50_1. The second precharge voltage is a source voltage of the second transistor 232 in which the source voltage has a voltage value obtained by adding a threshold voltage Vₜₕ₂ of the second transistor 232 to the gate voltage (gray-scale voltage VA1).

The amplifier 225 buffers the gray-scale voltage VA1 and the output voltage of the amplifier 225 is output to the signal line 50_1 through the output switch 226. The amplifier 225 is a voltage follower, that is, a buffer having a gain of “1.” Accordingly, the amplifier 225 generates an output voltage having the same voltage level as that of the input voltage (gray-scale voltage VA1) and has a relatively high current driving capability.

The output switch 226 is opened and closed in response to an output control signal SO and a reverse output control signal SOB to selectively output the output signal of the amplifier 225 to the signal line 50_1. The output control signal SO is activated when the first and second precharge control signals SA and SB are inactivated as shown in FIG. 4. That is, the output control signal is activated to a high level at the drop edges of the first and second precharge control signals SA and SB and inactivated in response to the rising edge of the clock signal CLK1. Therefore, after precharging of the signal line 50_1 by the first and second precharge control signals SA and SB is completed, the output signal of the amplifier 225 is output to the signal line 50_1.

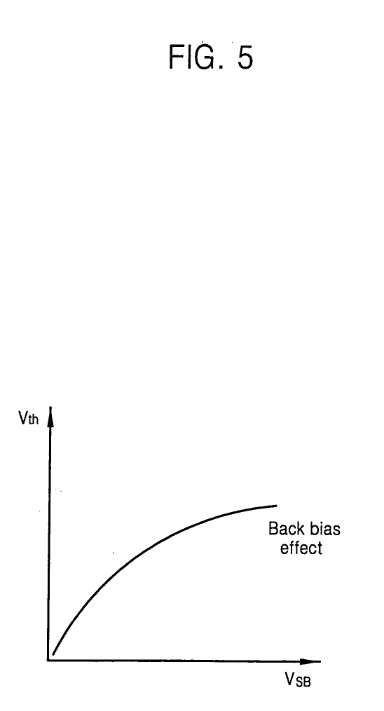

FIG. 5 shows the relationship of the threshold voltage Vₜₕ with the voltage difference V_{SB} between the source and the bulk (substrate). Generally, the threshold voltage Vₜₕ is a voltage between a gate and a source. The threshold voltage Vₜₕ does not go up if there is no voltage difference between the source and the bulk. However, if there is s a voltage difference V_{SB} between the source and the bulk, the threshold voltage Vₜₕ goes up. Thus, as shown in FIG. 5, when the voltage difference V_{SB} between a source and a bulk is increased, the threshold voltage Vₜₕ is increased as well. This phenomenon is called back bias effect or body effect. As described above, the threshold voltages Vₜₕ₁ and Vₜₕ₂ of the first and second transistors 231 and 232, as shown in FIG. 3, also can be varied according to the voltage level of the signal line 50_1.

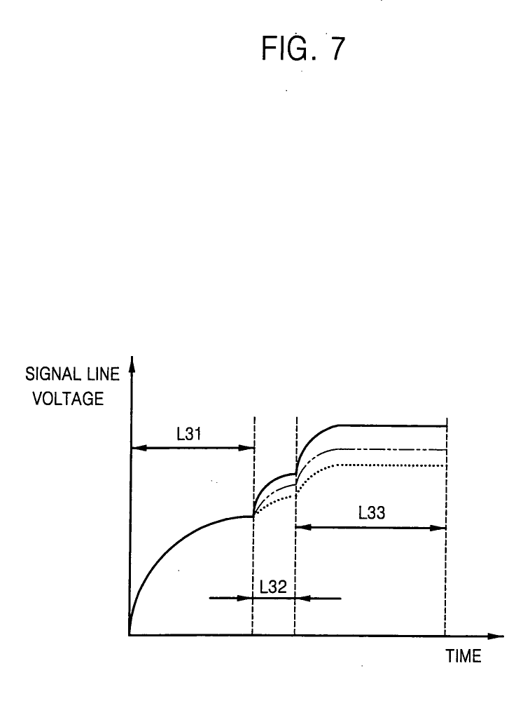

FIG. 7 is a graph showing the voltage level of the signal line 50_1 shown in FIG. 3. The first region L31 in the FIG. 7 graph is the period when the share control signal SS is activated, upon which the share switch 241 is turned on, whereby the voltage of the signal line 50_1 becomes the same as that of another adjacent signal line (for example, signal line 50_2).

The second region L32 is the period when the first or second precharge signal SA and SB is activated, whereby the signal line 50_1 is precharged to a predetermined voltage level by the precharging circuit 230. Here, it is shown that the first precharge signal SA is activated and, thus, the first precharge voltage generating circuit precharges the signal line 50_1. As shown in FIG. 7, at the point in time when the precharging is completed, a magnitude of the voltage of the signal line 50_1 varies according to a magnitude of the gray-scale voltage VA1. That is, the signal line 50_1 is precharged to a precharge voltage proportional, although not in linear proportion, to the gray-scale voltage.

The third region L33 is the period when the output control signal SO is activated, whereby the output voltage of the amplifier 225, that is, the gray-scale voltage VA1, is output to the signal line. Because the signal line is already precharged to a voltage proportional to the output voltage of the amplifier 225, that is the gray-scale voltage VA1, the voltage level of the signal line does not suddenly change but reaches a desired voltage level in a relatively short period of time.

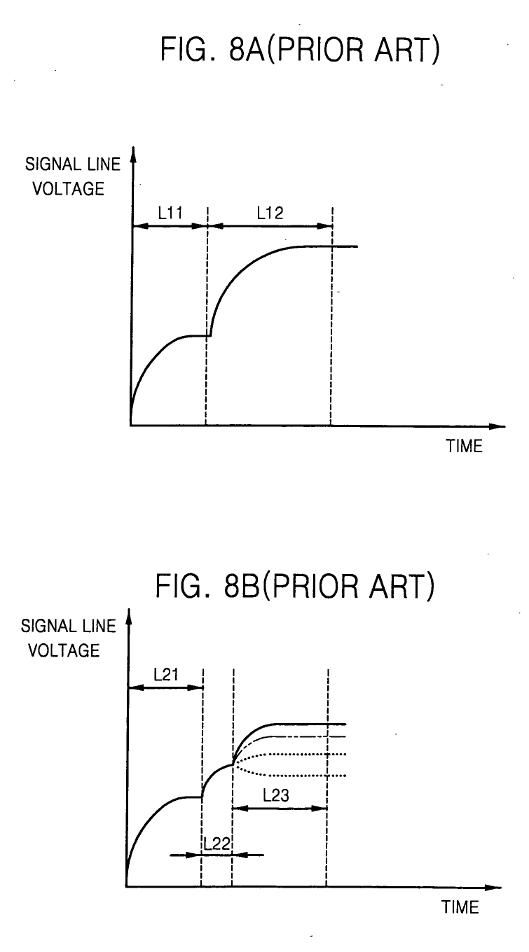

FIG. 8 contains graphs of the voltage level of the signal lines according the prior art. FIG. 8A illustrates an example in which a signal line precharging circuit is not included. The first region L11 is the period when the share switch is turned on, whereby the voltage of the signal line becomes the same as that of another adjacent signal line. The second region L12 is the period when the output voltage of the amplifier 225, that is, the gray-scale voltage VA1, is output to the signal line. In FIG. 8A, the output voltage of the amplifier, that is, the gray-scale voltage, is output to the signal line right after completion of the voltage sharing, because the signal line precharging circuit is not provided. Therefore, as shown in the second region L12, the output voltage of the amplifier can cause the voltage level of the signal line to suddenly change. Accordingly, the peak voltage is instantaneously raised, which may cause EMI problems or heat generation problems.

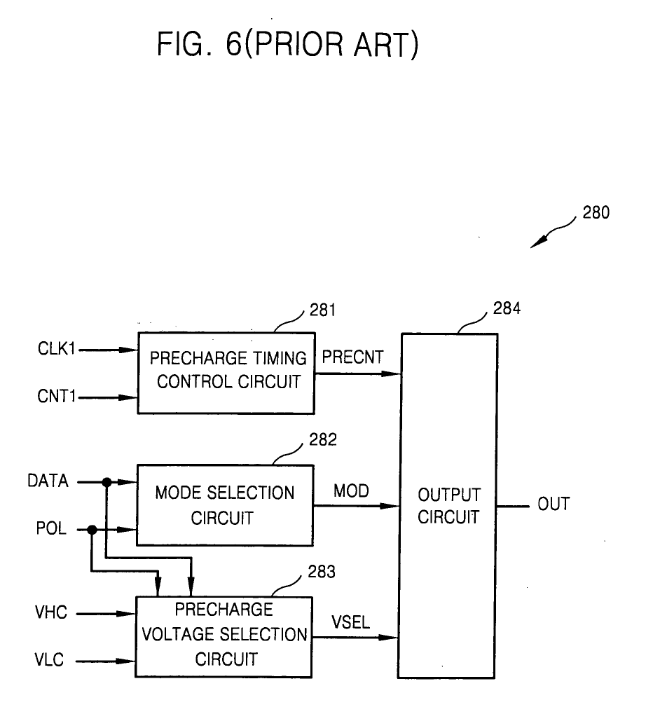

FIG. 8B shows the voltage level of the signal line in a display device according to a conventional LCD shown in FIG. 6. The first period L21 is the period when the share switch is turned on, whereby the voltage of the signal line becomes the same as that of another signal line. The second region L22 is the period when the signal line is precharged to a predetermined voltage level by a precharging circuit. In FIG. 8B, because the signal line is precharged to a voltage VSEL selected from two precharge voltages VHC and VLC having different voltage levels in response to the combination of the most significant bits (MSB) of the polar control signal POL and the data DATA, the precharge voltage level is not variable in accordance with the gray-scale voltage. Therefore, as shown in FIG. 8B, when the precharging is completed, the voltage of the signal line 50_1 is constant regardless of the gray-scale voltage.

The third region L23 is the period when the output voltage of the amplifier is output to the signal line. Thus, because the precharge voltage is independent from the output voltage of the amplifier in FIG. 8B, there may be a substantial difference between the precharge voltage and the output voltage of the amplifier, whereby the voltage level of the signal line can suddenly change.

As described above, because the signal line precharging circuit, in accordance with some embodiments of the present invention, determines the precharge voltage based on the gray-scale voltage without a separate internal voltage generator circuit, the chip area can be reduced. Also, by precharging the signal line to a voltage having a magnitude that is proportional to a magnitude of the gray-scale voltage, it may be possible to prevent or reduce the likelihood of sudden changes in the voltage level of the signal line, thereby reducing EMI and/or heat generation problems.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

That which is claimed:

1. A circuit for precharging signal lines of an LCD, comprising:
a precharge voltage generating circuit that is configured to generate a precharge voltage on a signal line responsive to a precharge control signal and a gray-scale voltage, the precharge voltage having a magnitude that is based on a magnitude of the gray-scale voltage.

2. The circuit of claim 1, wherein the precharge voltage generating circuit is a first precharge voltage generating circuit, the precharge control signal is a first precharge control signal, and the precharge voltage is a first precharge voltage, the circuit further comprising:
a second precharge voltage generating circuit that is configured to generate a second precharge voltage on the signal line responsive to a second precharge control signal and the gray-scale voltage, the second precharge voltage having a magnitude that is based on the magnitude of the gray-scale voltage.

3. The circuit of claim 2, wherein the first precharge voltage generating circuit comprises:
a first switch that is operable responsive to the first precharge control signal; and
a first transistor that comprises a first terminal that is connected to a first supply voltage, a second terminal that is connected to a terminal of the first switch and a third terminal that is connected to the signal line;
wherein the first precharge control signal is activated responsive to a clock signal and a polarity control signal.

4. The circuit of claim 3, wherein the second precharge voltage generating circuit comprises:
a second switch that is operable responsive to the second precharge control signal; and
a second transistor that comprises a first terminal that is connected to a second supply voltage, a second terminal that is connected to a terminal of the second switch and a third terminal that is connected to the signal line;
wherein the second precharge control signal is activated responsive to the clock signal and the polarity control signal.

5. The circuit of claim 4, wherein the first transistor is an NMOS transistor and the second transistor is PMOS transistor.

6. An LCD driver comprising:
a decoder that is configured to generate a gray-scale voltage responsive to source data;
an output buffer that is configured to drive a signal line of the LCD to an operating voltage responsive to the gray scale voltage; and
a precharge voltage generating circuit that is configured to generate a precharge voltage on the signal line responsive to a precharge control signal and the gray-scale voltage, the precharge voltage having a magnitude that is based on a magnitude of the gray-scale voltage.

7. The LCD driver of claim 6, wherein the precharge voltage generating circuit is a first precharge voltage generating circuit, the precharge control signal is a first precharge control signal, and the precharge voltage is a first precharge voltage, the LCD driver further comprising:
a second precharge voltage generating circuit that is configured to generate a second precharge voltage on the signal line responsive to a second precharge control signal and the gray-scale voltage, the second precharge voltage having a magnitude that is based on the magnitude of the gray-scale voltage.

8. The LCD driver of claim 7, wherein the first precharge voltage generating circuit comprises:
a first switch that is operable responsive to the first precharge control signal; and
a first transistor that comprises a first terminal that is connected to a first supply voltage, a second terminal that is connected to a terminal of the first switch and a third terminal that is connected to the signal line;
wherein the first precharge control signal is activated responsive to a clock signal and a polarity control signal.

9. The LCD driver of claim 8, wherein the second precharge voltage generating circuit comprises:
a second switch that is operable responsive to the second precharge control signal; and
a second transistor that comprises a first terminal that is connected to a second supply voltage, a second terminal that is connected to a terminal of the second switch and a third terminal that is connected to the signal line;
wherein the second precharge control signal is activated responsive to the clock signal and the polarity control signal.

10. The LCD driver of claim 9, wherein the first transistor is an NMOS transistor and the second transistor is PMOS transistor.

11. The LCD driver of claim 10, wherein the first precharge voltage is obtained by subtracting a threshold voltage of the first transistor from the gray-scale voltage and the second precharge voltage is a voltage obtained by adding a threshold voltage of the second transistor to the gray-scale voltage.

12. The LCD driver of claim 6, further comprising:
an output switch that couples the output buffer to the signal line and is operable responsive to an output control signal; and
a share switch that couples the signal line to another signal line and is operable responsive to a share control signal.

13. LCD system comprising:
a TFT-LCD panel; and
at least one driving device that is configured to drive the TFT-LCD panel, each of the at least one driving device comprising:
a decoder that is configured to generate a gray-scale voltage responsive to source data;
an output buffer that is configured to drive a signal line of the LCD to an operating voltage responsive to the gray scale voltage; and
a precharge voltage generating circuit that is configured to generate a precharge voltage on the signal line responsive to a precharge control signal and the gray-scale voltage, the precharge voltage having a magnitude that is based on a magnitude of the gray-scale voltage.

14. The LCD system of claim 13, wherein the precharge voltage generating circuit is a first precharge voltage generating circuit, the precharge control signal is a first precharge control signal, and the precharge voltage is a first precharge voltage, the at least one driving device further comprising:
a second precharge voltage generating circuit that is configured to generate a second precharge voltage on the signal line responsive to a second precharge control signal and the gray-scale voltage, the second precharge voltage having a magnitude that is based on the magnitude of the gray-scale voltage.

15. The LCD system of claim 14, wherein the first precharge voltage generating circuit comprises:
a first switch that is operable responsive to the first precharge control signal; and
an NMOS transistor that comprises a first terminal that is connected to a first supply voltage, a second terminal that is connected to a terminal of the first switch and a third terminal that is connected to the signal line;
wherein the second precharge voltage generating circuit comprises:
a second switch that is operable responsive to the second precharge control signal; and
a PMOS transistor that comprises a first terminal that is connected to a second supply voltage, a second terminal that is connected to a terminal of the second switch and a third terminal that is connected to the signal line.

16. A method of precharging signal lines of an LCD, comprising:
generating a precharge voltage on a signal line responsive to a precharge control signal and a gray-scale voltage, the precharge voltage having a magnitude that is based on a magnitude of the gray-scale voltage.

17. The method of claim 16, wherein the precharge control signal is a first precharge control signal and the precharge voltage is a first precharge voltage, the method further comprising:
generating a second precharge voltage on the signal line responsive to a second precharge control signal and the gray-scale voltage, the second precharge voltage having a magnitude that is based on the magnitude of the gray-scale voltage.

18. A method of operating an LCD system, comprising:
providing a TFT-LCD panel having a plurality of signal lines;
generating a gray-scale voltage responsive to source data;
driving a respective one of the signal lines of the TFT-LCD panel to an operating voltage responsive to the gray scale voltage; and
generating a precharge voltage on the signal line responsive to a precharge control signal and the gray-scale voltage, the precharge voltage having a magnitude that is based on a magnitude of the gray-scale voltage.
